(19) United States
(12) Patent Application Publication
(10) Pub. No.: US 2015/0234924 A1
(43) Pub. Date: Aug. 20, 2015

(54) SYSTEM AND METHOD FOR CONTROLLED SYNDICATION AND POPULATION OF DATABASE INFORMATION

(71) Applicant: Sticky Technologies, LLC, Las Vegas, NV (US)

(72) Inventor: Andrew Schydlowsky, Las Vegas, NV (US)

(73) Assignee: Sticky Technologies, LLC, Las Vegas, NV (US)

(21) Appl. No.: 14/628,011

(22) Filed: Feb. 20, 2015

Related U.S. Application Data
(60) Provisional application No. 61/942,395, filed on Feb. 20, 2014.

(51) Int. Cl. G06F 17/30; G06Q 30/02; H04L 29/08

(52) U.S. Cl. CPC G06F 17/30864; G06F 17/30598; G06F 17/3082; G06F 17/30654; H04L 67/10; G06Q 30/0256

(57) ABSTRACT

A system and method for syndicating content is disclosed. The system includes a network, a client/moderator server and a database, a set of retailers, a client, a moderator, and a set of users each connected to the network. A video content provider is connected to the network and distributes a video. A widget application is implemented on a web page of a retailer. Users interact with the widget application to search for and view content about the client. Content is populated into the widget application from the database generated by the client or a syndication group. The client or the user optionally moderates the content. A user or the retailer initiates a conversation about the video through the widget application and selects a list of other users as the syndication group. The user and the syndication group interact through the widget application by sending and receiving comments in a conversation.

### CROSS-REFERENCE TO RELATED APPLICATION

This application claims priority to U.S. Provisional Application No. 61/942,395 filed Feb. 20, 2014. The patent application identified above is incorporated here by reference in its entirety to provide continuity of disclosure.

### FIELD OF THE INVENTION

The present invention relates to systems and methods for syndicating internet content. In particular, the present invention relates to a system and method of gathering the collective knowledge of a group of users related to sets of questions, answers, tips and comments related to internet content.

### BACKGROUND

Information regarding certain topics is located in various sources throughout the internet in the form of web pages, social media networks, and videos. Collecting all relevant portions of content information in response to requests for certain topics is a challenge, especially for manufacturers and content providers. For example, an internet user is searching for a pair shoes from a particular manufacturer. The user will typically access the manufacturer's website directly or through a search engine to find the pair of shoes. If the user has a question about the pair of shoes, the user will typically search for the answer on the webpage for the pair of shoes. However, if the user cannot readily and easily find the answer, the user will leave the webpage of the manufacturer to find the answer. As a result, the manufacturer typically loses a potential customer and sales revenue.

The prior art has attempted to solve this problem with limited success. For example, U.S. Pat. No. 6,026,148 to Dworkin, et al. discloses a computer-based system that facilitates exchange of information between users and expert respondents. The users post questions on a topic to a computer bulletin board or forum via telephone. The system allows respondents to answer questions and provide comments. However, the system in Dworkin requires users to dictate comments for transcription and posting to the computer bulletin board. As a result, the comments can be misheard leading to inaccurate transcription and information posted on the bulletin board. Further, such a comment transcription system cannot be performed in real time.

U.S. Pat. No. 7,809,664 to Heck discloses a system and method for automated learning from questions and answers communicated over social networks. The system observes the way people ask questions and how other users respond to those questions. The system further observes which questions are most helpful and analyzes those questions to identify characteristics of those questions that are most helpful. These observations are then used to enhance the way the system answers future questions. However, the system in Heck requires an initial training mode for the system in order to learn how to answer questions correctly, making the system susceptible to providing incorrect answers and inaccurate information.

U.S. Patent Publication No. 2013/0304758 to Gruber, et al. discloses a system for receiving user requests seeking an informational answer or performance of a task. The system includes a crowd source knowledge base and a crowd sourcing module. Upon a failure to provide a satisfactory response to the user request, a crowd sourcing information source is queried for an answer. A response to the user request is generated based on the answer received from the crowd sourcing information source. The system also includes a real-time answer lookup database. However, information is not shared between other users—each user only communicates with the system. As a result, users cannot directly access the requests and responses of other users.

Therefore, there is a need in the art for a system and method for syndicating and aggregating information in real time that is readily shared between users. There is a further need in the art for a system and method for syndicating information about content that stays with the regardless of the location of the content itself.

### SUMMARY

A system and method for syndicating content is disclosed. The system includes a network, a client/moderator server connected to the network, a set of retailers connected to the network, a client connected to the network, a moderator connected to the network, and a set of users connected to the network. The client/moderator server is further connected to a database. Each of the set of users, the set of retailers, the client, and the moderator accesses the client/moderator server through network with a computing device.

In one embodiment, a video content provider is connected to the network and distributes a video.

In one embodiment, a widget application is implemented on a web page of a retailer. Users interact with the widget application to search for and view information about the client. Information is populated into the widget application from the database. If a user enters a question in the widget application, an answer is automatically generated from the database. If the answer is not found in the database, the answer is generated by the client. In a preferred embodiment, the question is distributed to a syndication group to answer the question. The syndication group then submits an answer to the question. In one embodiment, the client or the moderator edits the question and/or the answer. In one embodiment, an advertisement is included with the question and/or the answer.

In another embodiment, the widget application is utilized for syndication of the video. A user initiates a conversation about the video through the widget application and selects a list of other users as the syndication group. The user and the syndication group interact through the widget application by sending and receiving comments in a conversation. The user optionally moderates the conversation.

In another embodiment, the retailer implements the widget application to syndicate a video. In this embodiment, the retailer customizes the design and functionality of the widget application and selects options to create the syndication group. Users then post comments using the widget application. The client optionally moderates the comments.

### BRIEF DESCRIPTION OF THE DRAWINGS

In the detailed description presented below, reference is made to the accompanying drawings.

FIG. 1 is a schematic of a system of a preferred embodiment.

FIG. 2A is an image of a webpage implementation of a preferred embodiment.

FIG. 2B is an image of a webpage implementation of a preferred embodiment.

FIG. 3 is a flowchart of a method for creating an interactive webpage of a preferred embodiment.

FIG. 4A is an image of a video webpage implementation of a preferred embodiment.

FIG. 4B is an image a frequency counter and a set of video sync data of a preferred embodiment.

FIG. 5 is a flowchart of a method for syndicating an interactive video of preferred embodiment.

FIG. 6 is an image of a public portal for syndicating an interactive video of a preferred embodiment.

FIG. 7 is an image of a conversation menu for syndicating an interactive video of a preferred embodiment.

FIG. 8 is a flowchart of a method for syndicating a user-moderated interactive video of a preferred embodiment.

### DETAILED DESCRIPTION

It will be appreciated by those skilled in the art that aspects of the present disclosure may be illustrated and described in any of a number of patentable classes or contexts including any new and useful process or machine or any new and useful improvement. Aspects of the present disclosure may be implemented entirely in hardware, entirely in software (including firmware, resident software, micro-code, etc.) or combining software and hardware implementation that may all generally be referred to herein as a “circuit,” “module,” “component,” or “system.” Further, aspects of the present disclosure may take the form of a computer program product embodied in one or more computer readable media having computer readable program code embodied thereon.

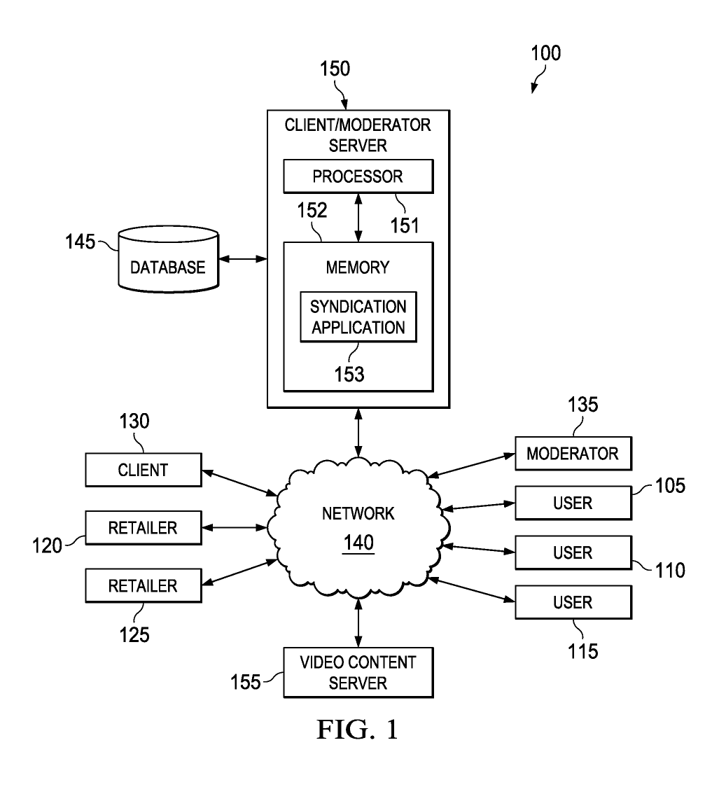

Referring to FIG. 1 in one embodiment, system 100 includes network 140, users 105, 110, and 115, each of which is connected to network 140, retailers 120 and 125, each of which is connected to network 140, client 130 connected to network 140, and moderator 135 connected to network 140. Client/moderator server 150 is connected to network 140. Client/moderator server 150 includes processor 151 and memory 152 connected to processor 151. Syndication application 153 is saved in memory 152 and executed by processor 151. Client/moderator server 150 is further connected to database 145. Each of client 130 and moderator 135 is in communication with database 145 through client/moderator server 150 and network 140. Video content server 155 is connected to network 140.

In a preferred embodiment, each of users 105, 110, and 115, retailers 120 and 125, client 130, and moderator 135 accesses client/moderator server 150 through network 140 with a computing device, such as a personal computer, smart phone, tablet computer, a set-top television provider receiver, and/or a smart television, using a website application or a native application. Any computing device known in the art may be employed.

In one embodiment, each of users 105, 110, and 115, retailers 120 and 125, client 130, and moderator 135 interact with client/moderator server 150 using an input device, such as a keyboard, mouse, touchpad, or any other pointing device, or a tap on a touch screen of the computing device. In another embodiment, gesture or voice activation is employed using a camera or microphone of the computing device.

In a preferred embodiment, video content server 155 distributes a video. In one embodiment, video content server 155 is a third party content provider, such as YouTube or Netflix. In another embodiment, video content server 155 is a television broadcaster. In another embodiment, video content server 155 is a live video stream provider.

In a preferred embodiment, network 140 is a wide area network such as the internet, but can include other wide area, local, and intranet networks, including cellular networks.

In a preferred embodiment, client/moderator server 150 is a server hosted by Amazon Web Services. Any suitable type of server may be employed.

In a preferred embodiment, syndication application 153 is a client-server web application. In a preferred embodiment, client/moderator server 150 employs PHP scripting language using Laravel framework and Node JS runtime environment. In this embodiment, the client side browser utilizes HTML, Javascript, and CSS, including third party software that includes BackboneJS, MarionetteJS, jQuery, and JWPlayer.

In one embodiment, system 100 is enabled by a set of servers connected across the internet and connected to a respective database.

In a preferred embodiment, database 145 is a MySQL database. Other database management systems known in the art may be employed.

In a preferred embodiment, retailer 120 is a product or service reseller such as Target or Wal-Mart.

In a preferred embodiment, client 130 is a product manufacturer or service provider such as Sony Corporation or H&R Block.

In a preferred embodiment, moderator 135 is a third party agent of client 130, such as an advertising agency or a social media consultant.

In a preferred embodiment, system 100 collects and organizes the collective knowledge of users 105, 110, and 115 related to commercial or entertainment topics such as retail distribution of goods and services or online videos or television shows or movies, shared between users 105, 110, and 115, retailers 120 and 125, clients 130 and moderators 135.

In one embodiment, database 145 is shared so that questions and answers of all users and retailers are stored. Retailers operate independently of each other. As a result, a disincentive of competition for questions and answers between customers of different retailers is eliminated. For example, one distributor of Nike® shoes is arguably a competitor of another distributor of Nike® shoes. However, questions from users of the different retailers are both answered by the client (Nike®), who then can provide the answers back to the retailers regardless of whose customer the user was. Hence, both retailers appear more knowledgeable to their respective users.

System 100 provides maximization of known questions. For example, any single topic has a finite number of questions and answers. By use of a “crowd source” technique, database 145 is populated with all possible questions and answers.

System 100 provides for a controlled syndication of questions and answers, which allows clients 130 and moderators 135 to selectively disperse questions and answers to both retailers and users.

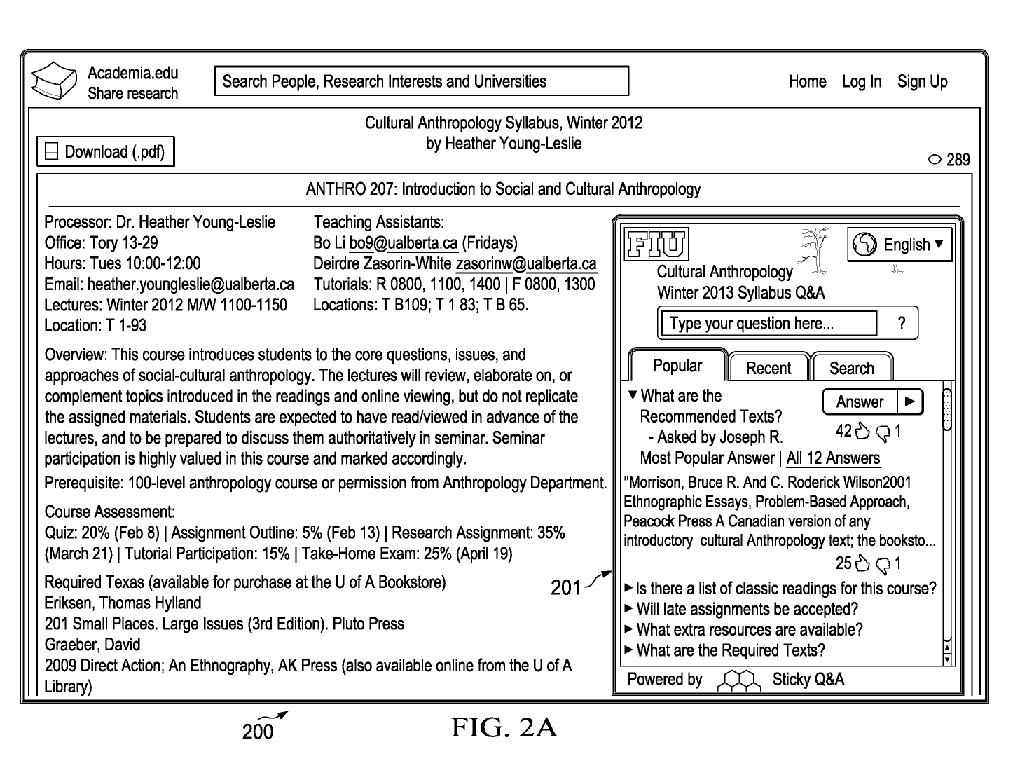

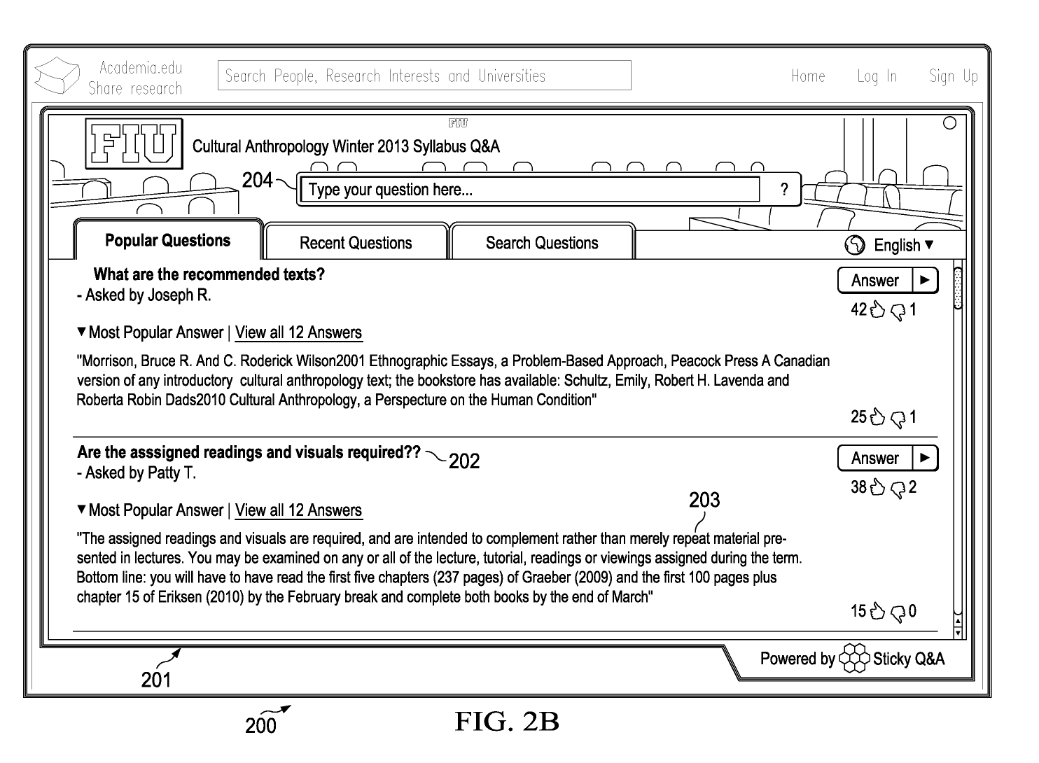

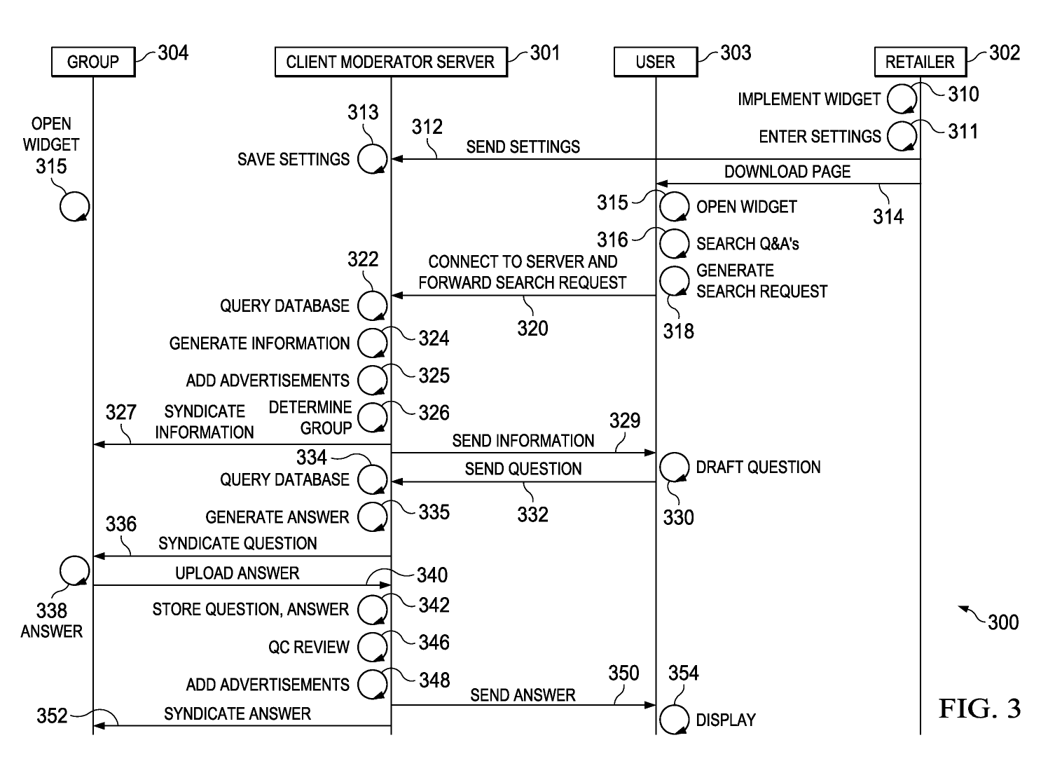

Referring to FIGS. 2A and 3B in one embodiment, webpage 200 includes a “widget” 201. Widget 201 includes a set of questions 202, each of which has a corresponding set of answers 203, and dialogue box 204.

In a preferred embodiment, widget 201 is implemented into webpage 200 with a set script lines for an HTML webpage.

In one embodiment, widget 201 includes pass through authorization. In this embodiment, widget 201 is implemented on any unit code browser (“UCB”) enabled application, smart phone, or intranet system.

In a preferred embodiment, widget 201 is written in Java. Any suitable programming language known in the art may be employed.

In a preferred embodiment, widget 201 displays a set of questions 202 and set of answers 203 which are browsable and searchable via dialogue box 204. In this embodiment, the set of answers 203 are generated and populated by a server or by a set of users to create an interactive webpage. For example, a first user posts question 202 using widget 201 seeking information that is not readily available on webpage 200. In one embodiment, answer 203 is automatically generated and posted, as will be further described below. In another embodiment, a second user posts an answer 203 to the question. In this way, information that is otherwise located on another website or from any other source is now included on webpage 200, thereby keeping the first user from seeking the desired information elsewhere and enabling webpage 200 to become interactive in real time.

Referring to FIG. 3, method 300 for syndicating information with a widget will be further described. At step 310, the widget is implemented on the webpage of retailer 302. In a preferred embodiment, the retailer adds a code section to a page header. This transfers new functionality to the webpage. At step 311, a set of settings for the widget is entered.

In a preferred embodiment, the set of settings includes custom commercial advertisements and selectable features, including graphics options, which control the display of the widget, i.e., the “look and feel” of the widget.

The set of settings further includes an option to include advertisements in the widget. In one embodiment, the advertisements are the same for each recipient. In another embodiment, the advertisements are different based a set of user demographics. The set of settings includes a set of group syndication criteria that determine how the widget is displayed and how information in the widget is shared. For example, retailer 302 selects whether “conversations”, i.e., sets of questions and related answers, are shared with other websites, each of which includes a corresponding widget. and how the information is shared, including by topic, by conversation, and/or by user location. Questions and answers are generally organized by domain. For example, questions and answers are organized in a hierarchy which reflects subject matter, manufacturer, general product, and specific product from which clients and moderators selectively provide access to users and retailers.

The set of settings further includes different types of conversations that are selected. For example, “public” is crowd moderated in that there is no interaction or moderation from the client. “Hosted” or “host moderated” is a conversation in which a client is moderating the conversation. “Private” conversations in which the host is any user who wants to host a private conversation. In a preferred embodiment, the host invites specific users, via email or text message, into the conversation. All types of conversations exist in parallel. For example, a private conversation is included on the same widget with a public conversation. In this example, users in the private conversation have access and can view the private conversation. Other users not in the private conversation cannot see the private conversation and only the public conversation. The set of settings further includes options for interaction restrictions for users. For example, restrictions are placed on types of content users are allowed to upload.

In this way, retailer 302 defines group 304, which refers to a set of users of a given widget, including all widgets on other websites that share a single conversation. The widgets are considered to be syndicated. Other criteria may be employed.

At step 312, the set of settings are sent to client/moderator server 301. At step 313, the set of settings are saved. At step 314, user 303 downloads and displays the widget at step 313. In one embodiment, the widget loads with a webpage and is displayed in a browser. At step 315, user 303 and group 304 open the widget.

At step 316, user 303 performs a search of information, questions and answers. In a preferred embodiment, user 303 scrolls through visible items or select tabs to display desired subjects. A search request for information is generated at step 318 by a menu selection. In one embodiment, the search request includes a request for a “tip” or “help” information about a product or service. At step 320, the widget connects to client/moderator server 301 directly through the network. At step 322, the requested information is queried automatically by accessing existing information in a database. At step 324, in one embodiment, if the information does not exist in the database, then the information is added. In a preferred embodiment, a client or a moderator adds the information to the database. At step 325, in one embodiment, commercial information or advertisements are optionally added. In one embodiment, an advertisement is appended to any question and answer that originates from different or unrelated retailers. For example, an advertisement for basketballs by Spalding® is appended to a question and answer session about Nike®. In another embodiment, the advertisement is appended to any question and answer that originates from the same or related advertisers. For example, an advertisement for Ford® trucks is appended to a question and answer conversation about Ford® trucks or trucks in general.

In one embodiment, the advertisements include retailer information relevant to a particular geo-location of user 303 and/or group 304. At step 326, a syndication group is determined from the set of settings. At step 327, the information is syndicated to group 304.

At step 329, the information and any advertisements are sent to user 303. If user 303 is not satisfied with the information, then, at step 330, user 303 drafts a question. At step 332, the question is sent to client/moderator server 301. At step 334, client/moderator server 301 automatically queries the database in order to generate an answer. In a preferred embodiment, search heuristics are employed to locate a nearest acceptable answer.

In a preferred embodiment, using full text search, the database is queried for question phrases and, using a relevancy index, to find answer data similar to the query. The results are stored into an array in memory with a unique index so that the same answer does not appear twice. The results are displayed to the user with the results with highest relevancy showing first.

For this, the phrase will be compared to other phrases in the database. For example, a user enters the question, “What is the best time to go on vacation during the year?” The system will examine the phrase and then split the phrase into the following combinations:

what is the best time to go on vacation during the year?

what is the best time to go on vacation during the

what is the best time to go on vacation

what is the best time to go on

until the combinations result in a phrase of two or three words.

For example, a user asks a question and the system attempts to determine if any recent questions that are the same to the asked question. If a match is determined, then the stored answer is returned. In this way, the system only submits new queries and the same queries are not stored, thereby reducing memory consumed by the database, bandwidth, and processing time.

If at step 334 no answer is available, then, at step 335, an answer is added. In a preferred embodiment, a client or a moderator adds the information to the database. In one embodiment, this step is performed in real time. In another embodiment, this step is not performed in real time. At step 336, client/moderator server 301 syndicates the question to group 304 who has also opened the widget. The widget displays the same subject of interest for both the group and the user, hence the group and the user, even though they are invisible to each other, are sharing the same information. At step 338, group 304 optionally generates an answer. At step 340, the answer is uploaded to the client/moderator. At step 342, the question and answer are stored in the database. At step 346, a quality control review of the answer is optionally performed. In a preferred embodiment, a client or a moderator performs this step. In this step, the answer is accepted or rejected. If rejected, then method 300 ends. If accepted, method 300 continues. For example, the answer is rejected if the answer contains profanity. In another embodiment, this step is performed automatically by employing a word filter script. At step 348, advertisements or commercial information are optionally added to the answer. At step 350, the answer is sent to user 303. At step 352, the answer is syndicated to group 304. At step 354, the answer and advertisement are displayed by user 303.

It should be understood that group 304 represents any number of other users, all connected to client/moderator 301 through the internet. It should also be understood that the question and answer can include tips or product use and comments from users related to the subject or product information stored in the database and displayed by the widget.

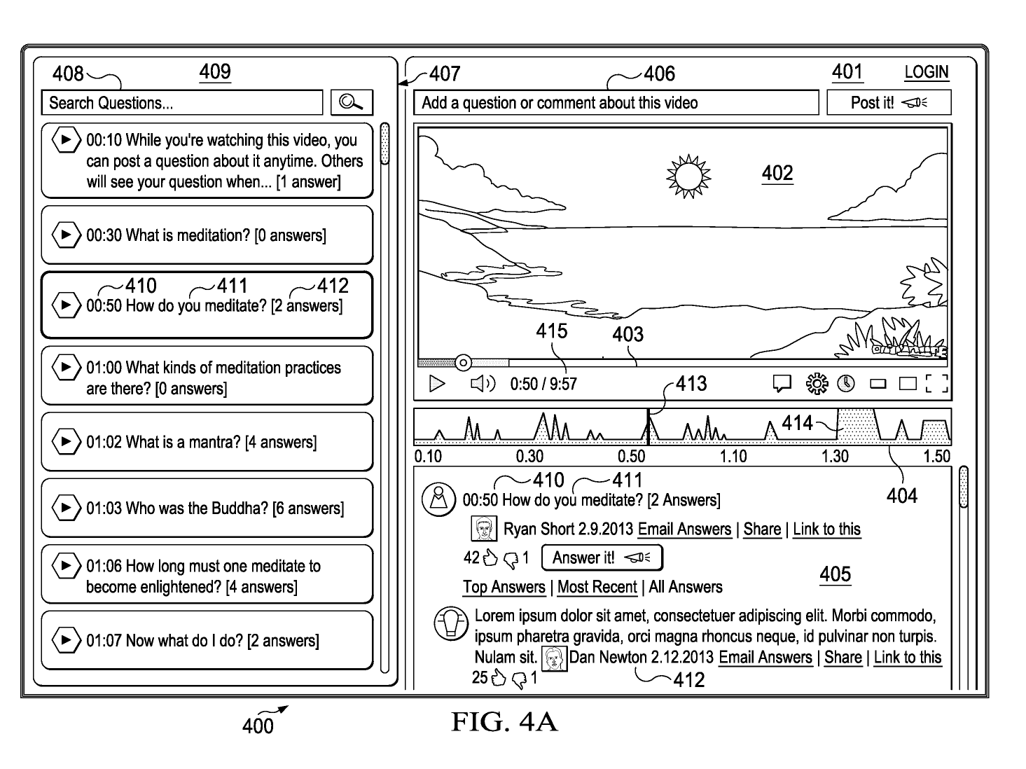

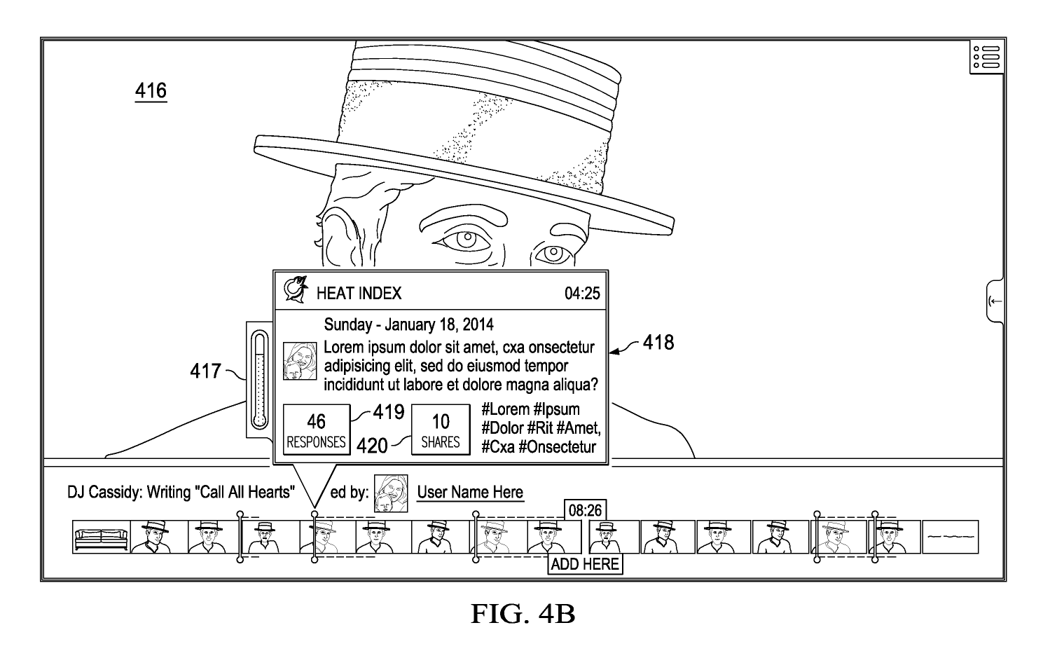

Referring to FIG. 4A in another embodiment, screen 400 has video widget 401. Video widget 401 includes video 402, time log 403, frequency counter 404, conversation display 405, and text box 406. Video widget 401 further includes conversation tool 407 which includes search field 408 and a set of questions 409. Each question 411 has time stamp 410 and a set of answers 412. Frequency counter 404 includes time bar 413, which synchronizes with time log 403, and time line 414. Video 402 includes duration 415.

In a preferred embodiment, widget 401 is implemented into a webpage with a set script lines for an HTML webpage.

In another embodiment, widget 401 is a mobile application.

In another embodiment, widget 401 is an internet browser plug-in. In this embodiment, widget 401 is overlaid onto any video viewed on the internet browser anywhere on the internet.

In another embodiment, widget 401 is set-top box application, such as a television service provider receiver. In another embodiment, widget 401 is a smart television application.

In one embodiment, widget 401 includes pass through authorization. In this embodiment, widget 401 is implemented on any unit code browser (“UCB”) enabled application, smart phone, or intranet system.

In a preferred embodiment, widget 401 is written in Java. Any suitable programming language known in the art may be employed.

In a preferred embodiment, video 402 is provided by a third party content provider such as YouTube. In another embodiment, video 402 is a live television broadcast. In another embodiment, video 402 is a live video stream, such as a live seminar. In another embodiment, video 402 is a user-generated video.

In a preferred embodiment, widget 401 is overlaid on video 402 as a “skin” and is customized, as will be further described below.

In a preferred embodiment, frequency counter 404 is generated using a template engine. In this embodiment, the HTML/CSS for webpage 400 is stored in a JavaScript-based template which is included in the code for widget 401 and is customized based upon the type of video player. For example, video 402 is a flash video or a QuickTime video, each having a respective template. In one embodiment, a CSS file is included which will provide styling for frequency counter 404 to overwrite basic styles.

In use, video 402 is played and time log 403 “clocks” through video 402 and displays the elapsed time. In one embodiment, when search field 408 is selected, video 402 is paused and the timestamp, in seconds, where video 402 was stopped is captured. Response text is entered into search field 408. A set of response data that includes the timestamp and the response text is sent to the client/moderator server, as will be further described below.

In another embodiment, where video 402 is a live broadcast or a live stream, when search field 408 is selected, video 402 continues to play. A set of response data that includes the time stamp at which the search field was selected, and the response text is sent to the client/moderator server, as will be further described below.

Conversation tool 407 displays a set of questions and answers 409 and each question 411 and each answer 412 is synchronized with time log 403 for display in conversation display 405.

When text is entered in text box 406, the text is associated with video 402 at the current time stamp and is added to the set of questions and answer 409 and displayed in conversation display 405.

Frequency counter 404 graphically displays the amount of questions 411 and answers 412 along time line 414. Time bar 413 “clocks” through the amount of questions 411 and answers 412 synchronously with time log 403 as video 402 is played. Time bar 413 is paused whenever video 402 is paused.

As time bar 413 moves along timeline 414, questions 411 and answers 412 are displayed in conversation display 405 according to time stamp 410. In a preferred embodiment, the data for frequency counter 404 is retrieved using a combination of third-party video display libraries and, depending on the source of video 402, is played in accordance with the source JavaScript-based API. Duration 415 is utilized to line up timeline 414 with video 402. Frequency counter 404 is incremented by retrieving duration 415 of video 401 and the number of questions 411 at the time stamp 410 the question was captured.

In a preferred embodiment, questions 411 and any corresponding answers 412 are displayed in timeline 414 conversation display 405 for a predetermined time window. If no questions are present, then timeline 414 and conversation display 405 are empty.

In a preferred embodiment, duration 415 is divided into a set of proportional segments to determine the predetermined time window. For example, the duration of a video is one minute and each segment is one-tenth of a minute, i.e., six seconds. Other methods of dividing time may be employed.

In a preferred embodiment, answers 412 include any type of content, including text, video, and images. In one embodiment, videos and/or images are posted as a links. In another embodiment, videos and/or images are posted directly in widget 401. In this embodiment, the videos and/or images are embedded into widget 401.

Referring to FIG. 4B in another embodiment, video 416 includes frequency indicator 417 designed to resemble a thermometer. Statistics window 418 displays a set of video sync data that includes responses indicator 419 and shares indicator 420. As can be seen, the widget sums the number of questions, answers, and comments and transforms the sum into a graphical format, i.e., responses indicator 419. The widget further transforms the sum of the questions, answers, and comments into an abstraction to indicate a thermometer, i.e., frequency indicator 417. The widget transforms the screen from a view of only video 416 to a view of the videos and the widget including frequency indicator 417, statistics window 418, responses indicator 419, and shares indicator 420.

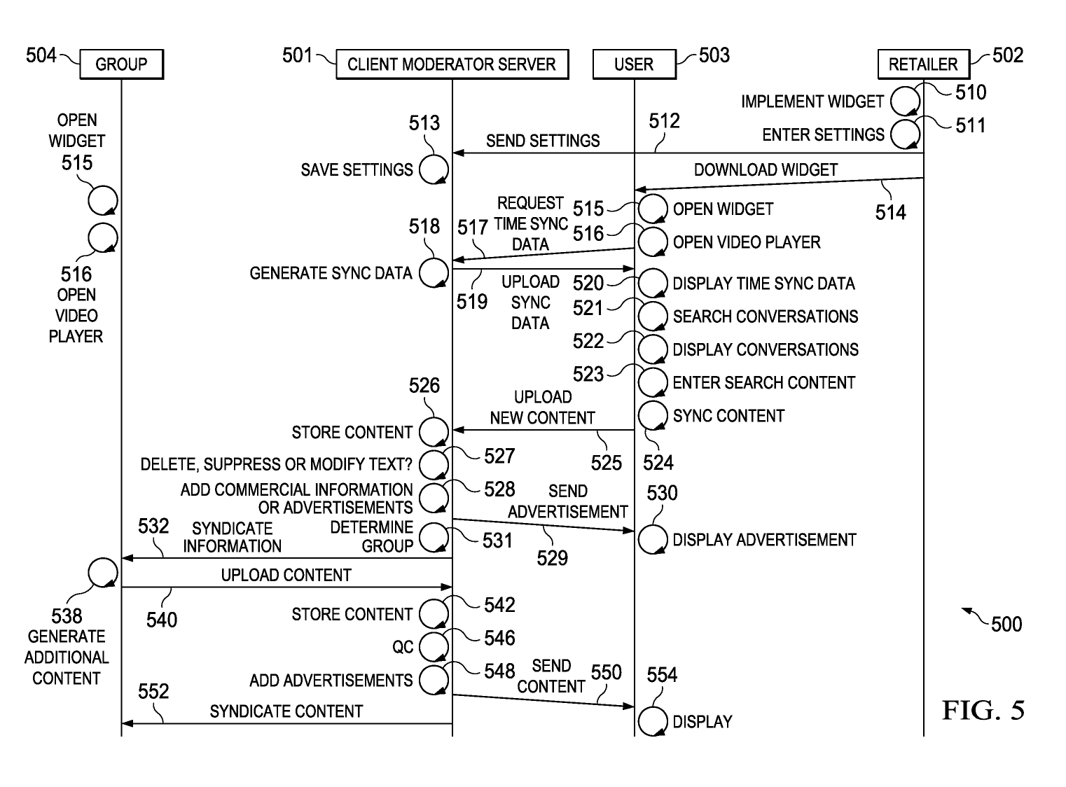

Referring to FIG. 5, method 500 for syndicating a video will be further described. At step 510, the widget is implemented. In a preferred embodiment, the retailer adds a code section to a page header of a webpage. For example, the code section

<script
src=“http://player.juststicky.com/js/embed/client.js/2001?unique=54d8c01943b51”></script>

is added to the page header. In another example, the code section

<script
src=“http://player.juststicky.com/js/embed/client.js/2001/sticky_player_target54d7e77bb382e?un
ique=54d2aa249105e”></script><iframe id=“sticky_player_target54d7e77bb382e” width=“560”
height=“325” src=“//player.vimeo.com/video/114158208” framborder=“0”
allowfullscreen></iframe>

is added to wrap the widget around the video source located at src=“//player.vimeo.com/video/114158208”.

This transfers new functionality to the webpage. At step 511, a set of settings for the widget is entered.

In a preferred embodiment, the set of settings in an account administration area includes custom commercial advertisements and selectable features, including graphics options, which control the display of the widget, i.e., the “look and feel” of the widget.

The set of settings further includes an option to include advertisements in the widget. In one embodiment, the advertisements are the same for each recipient. In another embodiment, the advertisements are different based on location of each user. The set of settings includes a set of group syndication criteria that determine how the widget is displayed and how information in the widget is shared. For example, retailer 502 selects whether “conversations”, i.e., sets of questions and related answers, are shared with other websites, each of which includes a respective widget and how the information is shared, including by topic, by conversation, and/or by user location. Questions and answers are generally organized by domain. For example, questions and answers are organized in a hierarchy which reflects subject matter, manufacturer, general product, and specific product from which clients and moderators selectively provide access to users and retailers.

The set of settings further includes different types of conversations that are selected. For example, “public” is crowd moderated in that there is no interaction or moderation from the client. “Hosted” or “host moderated” is a conversation in which a client is moderating the conversation. “Private” conversations in which the host is any user who wants to host a private conversation. In a preferred embodiment, the host invites specific users, via email or text message, into the conversation. All types of conversations exist in parallel. For example, a private conversation is included on the same widget with a public conversation. In this example, users in the private conversation have access and can view the private conversation. Other users not in the private conversation cannot see the private conversation and only the public conversation. The set of settings further includes options for interaction restrictions for users. For example, restrictions are placed on types of content users are allowed to upload.

At step 512, the set of settings are sent to client/moderator server 501. At step 513, the set of settings are saved. At step 514, user 503 downloads and displays the widget at step 513. At step 515, user 503 and group 504 open the widget. At step 516, the widget accesses and opens a video player. At step 517, the widget requests a set of data from the client/moderator server 501 that includes a set of questions and answers and data that indicates the frequency of questions asked about various subjects synchronized to a set of time designations related to the video, and displays them. At step 518, client/moderator server 501 automatically accesses the database to locate the sync data.

At step 519, the sync data and questions and answers are sent to the user. At step 520, the time sync data and questions and answers are displayed to the user. At step 521, user 503 performs a search of existing information, such as existing sample question and answer conversations that are linked to time periods in the video according to subject matter. In a preferred embodiment, user 503 optionally scrolls through visible items or select tabs to display desired subjects. If the user clicks on one of the listed questions in the timeline, the video is moved to that point in the timeline to be matched. A search request for information is generated at step 521 by a menu selection. The search request includes a “tip” or “help” information about a product or service. At step 522, the search results are displayed. At step 523, the user may enter new question, comment or tip in the text box as a user interaction. At step 524, the widget time syncs the user interaction to the video to generate a time stamp. In this step, a set of response data is created that includes the question, tip, or comment, and the time stamp. In this way, a receipt time of the user interaction is transformed into a synchronized format related to the time duration of the original video. At step 525, the content that includes the set of response data is uploaded to the client/moderator server 501. In one embodiment, this is an automatic push-pull process. At step 526, the content is stored. At step 527, action may be taken by the client or moderator to delete, suppress or modify the content. In one embodiment, actions by the client or the moderator are not in real time. In this embodiment, any human moderator intervention occurs at the moderator's convenience. In one embodiment, the moderation is performed in real time.

At step 528, in one embodiment, commercial information or advertisements are optionally added. In one embodiment, an advertisement is appended to any question and answer that originates from different or unrelated retailers. At step 529, any commercial information or advertisements are sent back to the user. At step 530, the advertisements are displayed. At step 531, the syndication group is determined based on the set of settings. At step 532, the information is then syndicated to group 504. At step 538, group 504 optionally generates additional content associated with a time stamp and/or a subject by the widget. In one embodiment, the content is a set of text. In another embodiment, the content is an image. In another embodiment, the content is a video. At step 540, the content is uploaded to the client/moderator. At step 542, the content is stored in the database by the client/moderator server and associated with the time stamp or subject matter. At step 546, the client or the moderator performs a quality control review of the additional text and may modify, suppress or delete it. At step 548, commercial information or advertisements are optionally added. At step 550, the content, including any commercial information or advertisements, is sent to user 503. At step 552, the content, including any commercial information or advertisements, is sent to group 504. At step 554, the additional content and any advertisement are displayed by user 503.

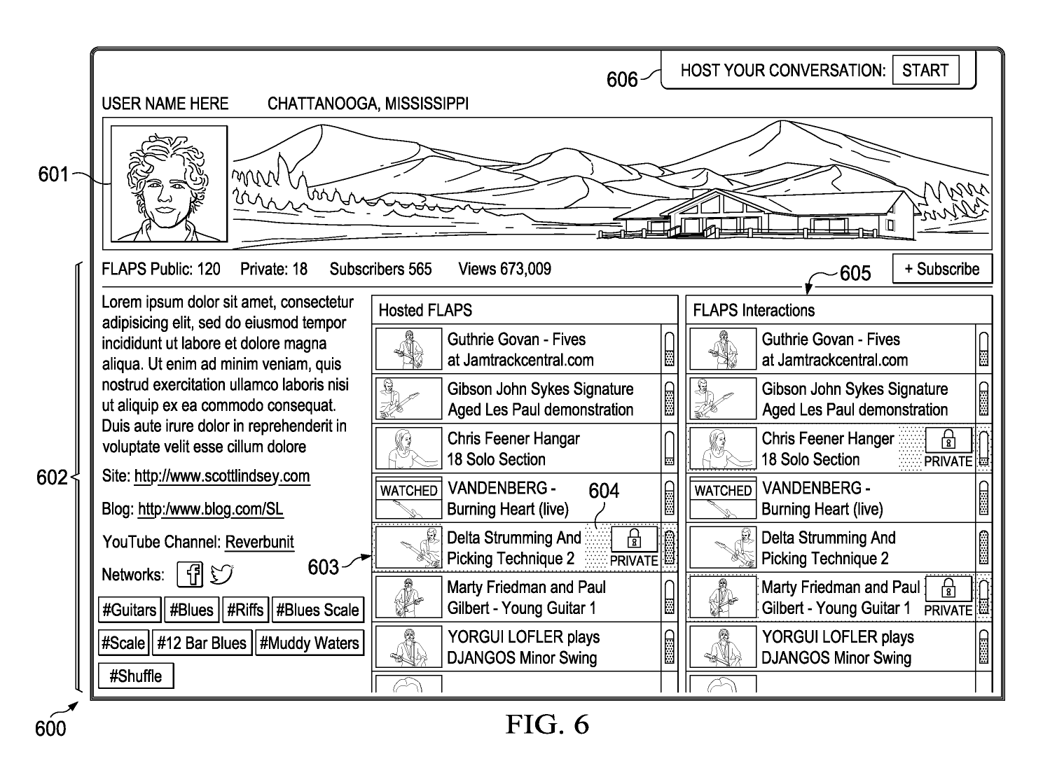

Referring to FIG. 6 in another embodiment, the video widget is implemented as public portal 600. In one embodiment, public portal 600 is a web application. In another embodiment, public portal 600 is a native client application. Public portal 600 includes a user profile 601 that includes a set of user demographics 602, hosted conversations 602, including private conversations 604 and comment history 605. Conversation menu 606 enables a user to initiate a conversation.

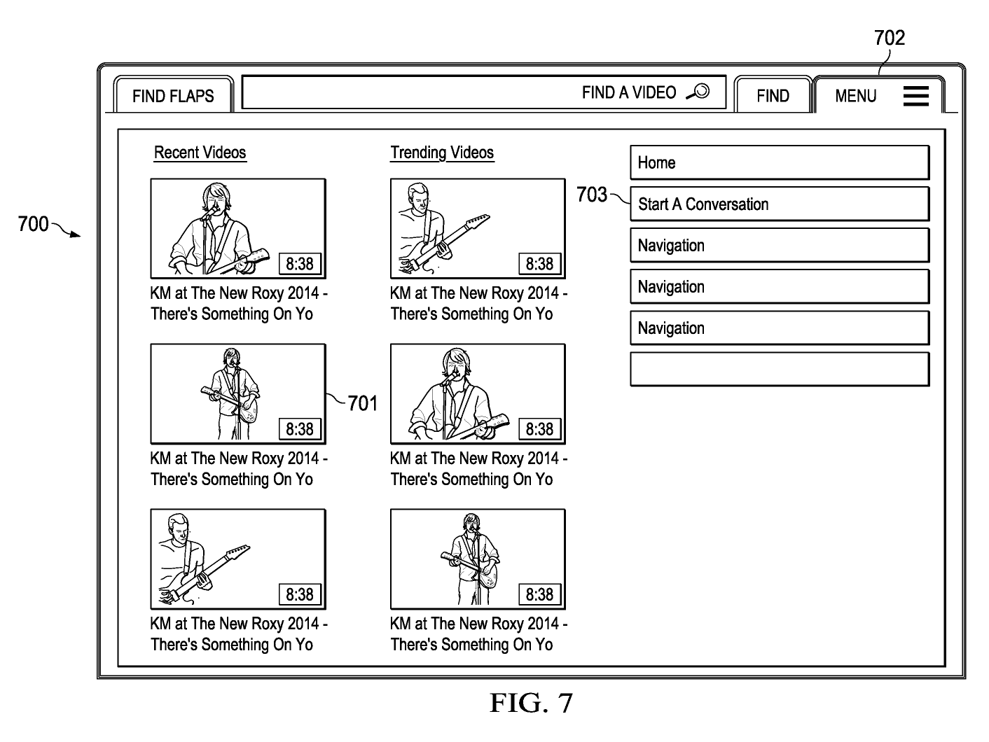

Referring to FIG. 7, conversation menu 700 includes a set of videos 701 from which to select and pull down menu 702. Pull down menu 702 includes start conversation button 703. In a preferred embodiment, a user selects a video from set of videos 701 and selects the start a conversation button to share the video to a set of other users and add content, as will be further described below.

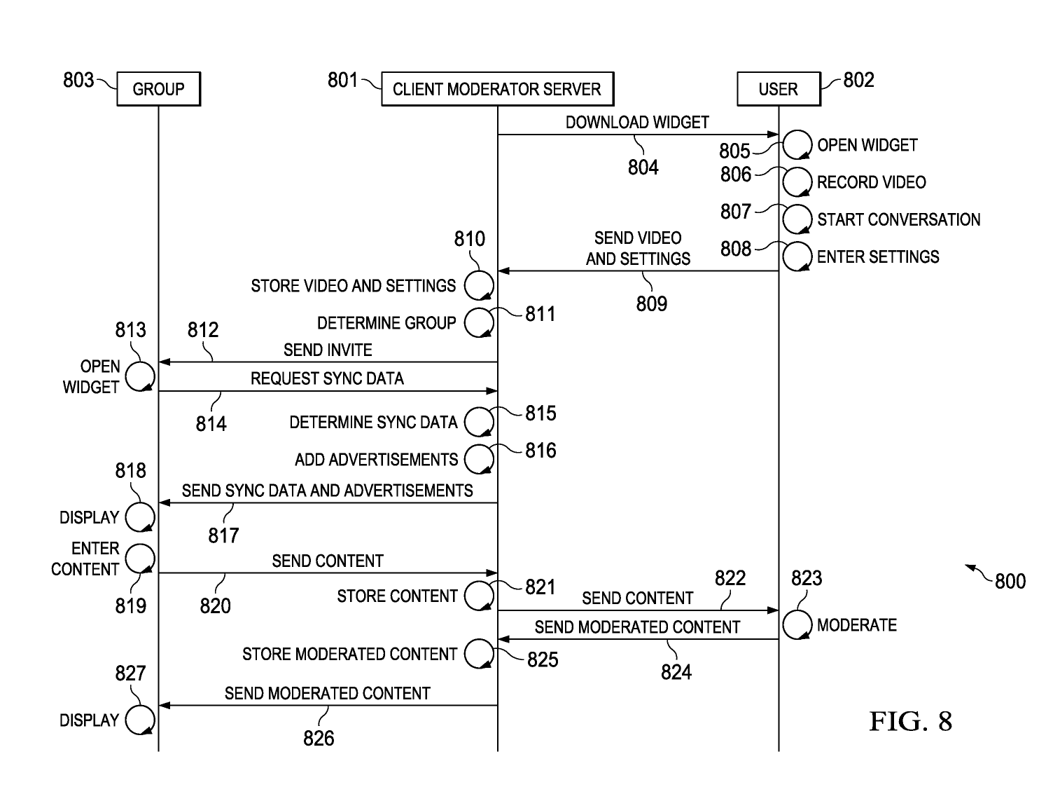

Referring to FIG. 8, method 800 for a user-moderated video syndication will be further described. At step 804, user 802 downloads a widget from client/moderator server 801. At step 805, user 802 opens the widget. At step 806, in one embodiment, user 802 records a video. At step 807, user 802 adds a comment to the video to start a conversation. In one embodiment, the video is a preexisting video, such as a live broadcast or live video stream. In another embodiment, the video is created by the user. At step 808, user 802 enters a set of settings for the conversation.

In a preferred embodiment, the set of settings includes a set of group syndication criteria that determine how information in the widget is shared. For example, user 802 selects whether the conversation is shared with other user, each of which accesses a respective widget, and how the information is shared, including by topic, by conversation, and/or by user location. Questions and answers are generally organized by domain. For example, questions and answers are organized in a hierarchy which reflects subject matter, content provider, television show, and specific video from which clients and moderators selectively provide access to users and retailers.

The set of settings further includes different types of conversations that are selected. For example, “public” is crowd moderated in that there is no interaction or moderation from the client. “Hosted” or “host moderated” is a conversation in which a client is moderating the conversation. “Private” conversations in which the host is any user who wants to host a private conversation. In a preferred embodiment, the host invites specific users, via email or text message, or a notification sent in the widget, into the conversation. All types of conversations exist in parallel. For example, a private conversation is included on the same widget with a public conversation. In this example, users in the private conversation have access and can view the private conversation. Other users not in the private conversation cannot see the private conversation and only the public conversation.

At step 809, the set of settings and any recorded video is sent to client/moderator server 801. At step 810, the set of settings and any recorded video is stored. At step 811, a syndication group is determined from the set of settings. At step 812, an invitation is sent to the determined group. At step 813, group 803 opens the widget. At step 814, the widget requests a set of sync data. At step 815, the client/moderator server 801 determines the set of sync data. In a preferred embodiment, the set of sync data includes the video and a set of questions and answers and data that indicates the frequency of questions asked about various subjects synchronized to a set of time stamps related to the video. At step 816, the client/moderator server 801 optionally adds commercial information and/or advertisements to the set of sync data. At step 817, the set of sync data and any accompanying commercial information and/or advertisements is sent to group 803 to syndicate the video. At step 818, the set of sync data and any commercial information and/or advertisements is displayed. At step 819, any user in group 803 optionally adds additional content to the syndicated video. In one embodiment, the content is a set of text. In another embodiment, the content is an image. In another embodiment, the content is a video.

At step 820, the content is sent to client/moderator server 801. At step 821, the content is stored. At step 822, the content is sent to user 802. At step 823, user 802 optionally moderates the content by deleting, suppressing, or adding to the content. At step 824, any moderated content is sent to client/moderator server 801. At step 825, the moderated content is stored. At step 826, the moderated content is sent to group 803. At step 827, the moderated content is displayed. In a preferred embodiment, steps 819, 820, 821, 822, 823, 824, 825, 826, and 827 are repeated to generate a continuous conversation in real time.

It will be appreciated by those skilled in the art that the disclosed embodiments have numerous applications. For example, given 1,000 websites wrapping the same video with the disclosed system, all websites would show the same “skin” or widget branding, all websites would contribute to and pull from the questions, comments, tips, answers that users were contributing to the database for that particular video, any user can add content which would be available throughout the network optionally without “review;” and advertising is sent throughout the network by the client/moderator server, based upon advertising server rules.

In another example, the client reviews and approves content to moderate the conversation. Advertising is controlled by the client and is delivered to each of the 1,000 websites based upon the advertising rules. The advertising is the same or is different depending on the settings.

In another example, the disclosed system enables the content to be syndicated and any information that is added to the content “travels” with the content across all web sites. In this way, any information that is not included on the website on which the original content is included may be added to the original content in order to centralize information about the original content to the original content itself.

It will be appreciated by those skilled in the art that the described embodiments disclose significantly more than an abstract idea including technical advancements in the field of data processing and a transformation of data which is directly related to real world objects and situations in that the disclosed embodiments enable a computer to operate more efficiently and solve a problem particular to the internet with a technical solution particular to the internet. Specifically, the disclosed embodiments solve the problem of retaining internet users by aggregating information generated by a third party onto an original web site or original video, thereby discouraging internet user from seeking the third party information elsewhere. Further, the aggregated information is prioritized so that no information is duplicated, resulting in a reduction of memory and bandwidth consumed by the disclosed embodiments.

It will be appreciated by those skilled in the art that modifications can be made to the embodiments disclosed and remain within the inventive concept. Therefore, this invention is not limited to the specific embodiments disclosed, but is intended to cover changes within the scope and spirit of the claims.

1. A syndication system comprising:
a network;
a video distributed through the network;
a set of widget applications connected to the network, each widget application of the set of widget applications overlaid onto the video;
a server connected to the network programmed to carry out the steps of:
receiving a set of response data;
determining a syndication group for the set of widget applications:
sending the set of response data to the syndication group;
receiving a set of content in response to the set of response data; and,
sending the set of response data to the syndication group.

2. The system of claim 1, wherein the set of response data comprises a response video attached to the video.

3. The system of claim 1, further comprising a client device connected to the network, wherein the server is further programmed to carry out the step of receiving a set of client moderation data for the set of response data.

4. The system of claim 1, wherein the server is further programmed to carry out the step of adding a set of advertisements to the set of response data.

5. The system of claim 1, further comprising a retailer device connected to the network and wherein the server is further programmed to carry out the steps of:
receiving a set of retailer settings for the set of widget applications; and,
determining the syndication group from the set of retailer settings.

6. The system of claim 1, wherein each of the set of widget applications is a mobile application.

7. The system of claim 1, wherein each of the set of widget applications is a web page application.

8. The system of claim 1, further comprising a user device connected to the network wherein the server is further programmed to carry out the steps of:
receiving a set of user settings; and,
determining the syndication group from the set of user settings.

9. The system of claim 1, wherein the server is further programmed to carry out the steps of:
receiving a set of moderated content; and,
sending the set of moderated content to the syndication group.

10. The system of claim 1, further comprising a content provider connected to the network, wherein the video is distributed by the content provider.

11. The system of claim 1, wherein the video is television broadcast.

12. The system of claim 1, wherein the video is a live stream.

13. A method for syndication comprising the steps of:
receiving a set of settings;
receiving a search query;
determining an automatic answer for the search query;
receiving a client answer for the search query based on the automatic answer;
determining a syndication group from the set of settings;
receiving a question based on the client answer;
receiving an answer to the search query; and,
syndicating the question and the answer to the syndication group.

14. The method of claim 13, further comprising the step of moderating the answer.

15. The method of claim 13, further comprising the step of appending an advertisement to the client answer.

16. The method of claim 13, further comprising the step of implementing a widget on a web page.

17. A method for syndicating a video through a set of widget applications comprising the steps of:
receiving a set of response data for the video;
determining a syndication group for the set of widget applications;
sending the set of response data to the syndication group;
receiving a set of content in response to the set of response data; and,
sending the set of response data to the syndication group.

18. The method of claim 17, wherein the step of determining a syndication group further comprises the step of determining a subset of widget applications from the set of widget applications.

19. The method of claim 17, further comprising the step of recording the video.

20. The method of claim 17, further comprising the step of adding an advertisement to the set of response data.
